(19) United States
(12) Patent Application Publication
(10) Pub. No.: US 2026/0182565 A1
(43) Pub. Date: Jul. 2, 2026

(54) ADJUVANT COMPOSITION FOR BIOLOGICAL SUBSTRATES

(71) Applicant: Momentive Performance Materials Inc., Niskayuna, NY (US)

(72) Inventors: Yi Xu, Upper Saddle River, NJ (US); Jeferson André Naue, Mahopac, NY (US); Benjamin Langendorf, London (GB)

(21) Appl. No.: 19/429,229

(22) Filed: Dec. 22, 2025

Related U.S. Application Data
(60) Provisional application No. 63/739,215, filed on Dec. 27, 2024.

(51) Int. Cl. A01N 25/24; A01N 25/04; A01N 25/30; A01P 1/00

(52) U.S. Cl. CPC A01N 25/24; A01N 25/04; A01N 25/30; A01P 1/00

(57) ABSTRACT

An adjuvant composition is shown and described herein. The adjuvant composition is suitable for use in conjunction with agrochemical compositions and for application to agricultural substrates. The adjuvant composition comprises: (i) an unsaturated oil and/or a transesterified unsaturated oil; (ii) a trisiloxane alkoxylate surfactant, (iii) a vinyl lactam polymer and optionally (iv) an alcohol. The compositions can function to enhance one or more properties such as, for example, rainfastness spreadability, emulsion stability, and/or reduction in the formation of driftable fines.

### CROSS-REFERENCE TO RELATED APPLICATIONS

This application claims priority to and the benefit of U.S. Provisional Patent Application No. 63/739,215 filed on Dec. 27, 2024, the entire disclosure of which is incorporated herein by reference in its entirety.

### FIELD OF INVENTION

The present invention relates to an adjuvant composition suitable for application to agricultural substrates. In particular, the present invention relates to adjuvant compositions that facilitate retention of agricultural chemicals on agricultural substrates.

### BACKGROUND

Agrochemicals are applied to agricultural substrates, e.g., plants, crops, and the like, for a variety of reasons such as, for example, to provide nutrients to the substrate or protection from pests and diseases. The agrochemicals either work by contact (i.e., contact pesticides) or are absorbed into the agricultural substrate by infiltration or penetration (i.e., systemic pesticides). On both cases, the agrochemical needs to remain in contact with the agricultural substrate for certain period of time to provide the intended benefit. If rain occurs shortly after treating the agricultural substrates, the agrochemicals can be washed away such that they will not be completely effective in providing the intended benefit (i.e., have reduced efficacy). When this happens, the agrochemicals may need to be reapplied to the substrates, which requires additional costs in terms of agrochemical usage and has negative environmental impacts.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is an adjuvant composition. The adjuvant composition comprises (i) an unsaturated oil and/or a transesterified unsaturated oil; (ii) a trisiloxane alkoxylate surfactant, (iii) a vinyl lactam polymer and optionally, (iv) an alcohol. A composition in accordance with the present technology may provide one or more of the following benefits in the application of agrochemicals to an agricultural substrate: better adhesion, enhanced rainfastening, better spreadability, superior emulsion stability, UV protection, reduced droplet evaporation and/or reduction in spray driftable fines. A composition in accordance with the present technology may be suitable for use as an adjuvant for application of agrochemicals or active ingredients to an agricultural substrate.

In one aspect, provided is an adjuvant composition comprising: an oil selected from a seed oil, a transesterified seed oil, or mixture thereof, wherein the oil is present in an amount of from about 50% to about 90% by weight of the composition; a trisiloxane alkoxylate in an amount of from about 5% to about 30% by weight of the composition; and a vinyl lactam polymer in an amount of from about 5% to about 30% by weight of the composition.

In one embodiment, the seed oil is selected from bitter gourd oil, borage oil, calendula oil, canola oil, castor oil, china wood oil, coconut oil, conifer seed oil, corn oil, cottonseed oil, dehydrated castor oil, flaxseed oil, grape seed oil, Jacaranda mimosifolia seed oil, linseed oil, olive oil, palm oil, palm kernel oil, peanut oil, pomegranate seed oil, rapeseed oil, safflower oil, snake gourd oil, soya (bean) oil, sunflower oil, tung oil, wheat germ oil, or a mixture of two or more thereof.

In one embodiment in accordance with any of the previous embodiments, the transesterified seed oil is selected from a methylated or ethylated seed oil. In one embodiment, the oil comprises corn oil. In one embodiment, the oil comprises methylate soybean oil, methylated rapeseed oil, or ethylated canola oil.

In one embodiment in accordance with any of the previous embodiments, the trisiloxane alkoxylate comprises a compound of the formula (I):

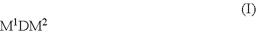

where

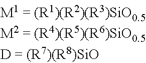

where
R¹, R², R³, R⁴, R⁵, and R⁷ are independently selected from the group consisting of a monovalent hydrocarbon radical having from 1-4 carbon atoms;
either R⁶ is R⁹ and R⁸ is Z, or Reis Z and R⁸ is R⁹, where R⁹ is a monovalent hydrocarbon radical having from 1-4 carbon atoms;
Z is a polyalkyleneoxide group of the general formula:

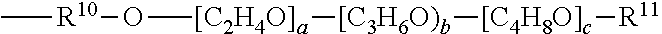

where subscript a is 2 to 9, b is 0 to 7, and c is 0 to 7, and satisfy the following relationships:

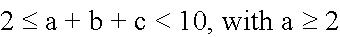

and with the limitation that when b+c=0, then a is 5 to 9,
R¹⁰ is a linear or branched divalent hydrocarbon group of 3 to 4 carbon atoms; and
R¹¹ is selected from the group consisting of H, monovalent hydrocarbon radicals of from 1 to 6 carbon atoms and acetyl.

In one embodiment, b+c is 0.

In one embodiment in accordance with any of the previous embodiments, the composition comprises a trisiloxane alkoxylate of the formula (II);

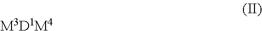

where

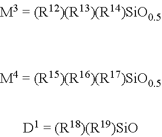

where
R¹², R¹³, R¹⁴, R¹⁵, R¹⁷, and R¹⁸ are independently selected from the group consisting of a monovalent hydrocarbon radical having from 1-4 carbon atoms;
either R¹⁶ is R²⁰ and R¹⁹ is Q, or R¹⁶ is Q and R¹⁹ is R²⁰, where R²⁰ is a monovalent hydrocarbon radical having from 1-4 carbon atoms;
Q is a polyalkyleneoxide group of the general formula:

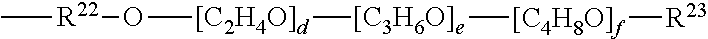

where subscript d is 3 to 35, e is 0 to 50, and f is 0 to 20, provided that e+f is ≥1, and 10≤d+e+f≤75 with d≥5;

In one embodiment in accordance with any of the previous embodiments, R²² is a linear or branched divalent hydrocarbon group of 3 to 4 carbon atoms; and R²³ is selected from the group consisting of H, monovalent hydrocarbon radicals of from 1 to 6 carbon atoms and acetyl.

In one embodiment in accordance with any of the previous embodiments, b+c=0, and a=6-8.

In one embodiment in accordance with any of the previous embodiments, a=5-9, b=0, c=0, d=8-12, e=2-5, f=0, and d+e+f≥10.

In one embodiment in accordance with any of the previous embodiments, a=5-8, b=2-3, c=0, a+b+c<10, d=7-12, e=20-30, and f=0.

In one embodiment in accordance with any of the previous embodiments, a=5-7, b=2-3, c=0, a+b+c<10, d=10-12, e=12-18, and f=0 or 1.

In one embodiment in accordance with any of the previous embodiments, a=5-7, b=1-3, c=0, a+b+c<10, d=10-12, e=12-18, and f=0 or 1.

In one embodiment in accordance with any of the previous embodiments, a ratio of the trisiloxane alkoxylate of the Formula (I) to the trisiloxane alkoxylate of the Formula (II) is from about 90:10 to about 10:90 based on the total weight of the trisiloxane alkoxylate of Formula (I) and the trisiloxane alkoxylate of Formula (II).

In one embodiment in accordance with any of the previous embodiments, the vinyl lactam polymer is selected from a copolymer of (i) a heterocyclic vinyl lactam having 4 to 6 ring carbon atoms, and (ii) a (co) monomer selected from an olefin, a vinyl ester, or mixture thereof.

In one embodiment in accordance with any of the previous embodiments, the heterocyclic vinyl lactam is selected from N-vinyl pyrrolidone, N-vinyl caprolactam, or vinyl methyl pyrrolidone.

In one embodiment in accordance with any of the previous embodiments, the (co) monomer is selected from a C2-C20 olefin.

In one embodiment in accordance with any of the previous embodiments, the monomer is selected from vinyl formate, vinyl acetate, vinyl propionate, vinyl butyrate, vinyl isobutyrate, vinyl pivalate, vinyl versatate, vinyl caproate, vinyl caprylate, vinyl laurate, vinyl palmitate, vinyl stearate, vinyl oleate, vinyl benzoate, or a mixture of two or more thereof.

In one embodiment in accordance with any of the previous embodiments, the vinyl lactam polymer comprises from about 5% to about 95% of the vinyl lactam (i), and from about 95% to about 5% of the (co) monomer (ii).

In one embodiment in accordance with any of the previous embodiments, the vinyl lactam polymer comprises a vinylpyrrolidone copolymer comprising a copolymer of a vinylpyrrolidone and an alpha-olefin.

In one embodiment in accordance with any of the previous embodiments, the vinyl lactam polymer has a number average molecular weight of from about 1,000 to about 100,000.

In one embodiment in accordance with any of the previous embodiments, the vinyl lactam polymer is soluble in the oil.

In one embodiment in accordance with any of the previous embodiments, further comprises an alcohol.

In one embodiment, the alcohol has 1 to 24 carbon atoms.

In one embodiment, the alcohol has 8 to 24 carbon atoms.

In one embodiment in accordance with any of the previous embodiments, the alcohol is present in an amount of from about 0.1 wt. % to about 10 wt. % based on the weight of the composition.

In one embodiment in accordance with any of the previous embodiments, the oil is bitter gourd, borage, calendula, canola, castor, china wood, coconut, conifer seed, corn, cottonseed, dehydrated castor, flaxseed, grape seed, Jacaranda mimosifolia seed, linseed, olive, palm, palm kernel, peanut, pomegranate seed, rapeseed, safflower, snake gourd, soya (bean), sunflower, tung, and/or wheat germ, or a mixture of two or more thereof.

In one embodiment in accordance with any of the previous embodiments, the composition provides microbial pesticides or biochemical pesticides with protection from ultraviolet radiation.

In another aspect, provided is an agrochemical composition comprising the adjuvant composition of any of the previous embodiments and an agrochemical.

In still another aspect, provided is an agrochemical composition comprising the adjuvant composition of any one of the previous embodiments and a microbial pesticide, wherein the composition provides the microbial pesticide with protection from ultraviolet radiation.

In one embodiment in accordance with any of the previous embodiments, the agrochemical is selected from a herbicide, an insecticide, a plant growth regulator, a fungicide, a miticide, an acaricide, a fertilizer, a biocide, a micronutrient, a plant nutritional, a microbial pesticide, a biochemical pesticide, a biostimulant, or a combination of two or more thereof.

In yet another aspect, provided is a method of treating an agricultural substrate comprising applying an agrochemical and the composition of any one of the previous embodiments to an agricultural substrate.

In one embodiment, the agrochemical and the adjuvant composition are provided as a pre-mixed solution.

In one embodiment, the adjuvant composition is provided as a tank side additive and is applied to the agricultural substrate at the same time or after application of the agrochemical.

In one embodiment in accordance with any of the previous embodiments, the agricultural substrate is selected from the group consisting of a foliar substrate, seed substrate and a shoot substrate.

In another aspect, provided is a use of an adjuvant composition of any one of the previous embodiments for improving the rainfastness of an agricultural composition.

In an embodiment of the use, an agrochemical ingredient of said agricultural composition is held on an agricultural substrate in an amount such that more than 10% of an amount deposited on a Parafilm M substrate is recovered from the substrate when said substrate is subject to simulated rainfall equivalent to 7 mm in an hour, said simulated rain commencing 120 minutes after application of the substance in conditions of relative humidity of 50% or less.

In a further aspect, provided is a method for imparting rainfastness to an agrochemical, the method comprising contacting the agrochemical with the adjuvant composition of any one of the previous embodiments to prepare a rainfastening agrochemical composition and dispensing the rainfastening agrochemical composition on an agricultural substrate.

The following description and the figures disclose various illustrative aspects. Some improvements and novel aspects may be expressly identified, while others may be apparent from the description and drawings.

### BRIEF DESCRIPTION OF THE DRAWINGS

The accompanying figures illustrate various systems, apparatuses, devices and related methods, in which like reference characters refer to like parts throughout, and in which:

FIG. 1 is a graph of the Turbiscan Stability Index of various compositions including an adjuvant in accordance with the present technology.

FIG. 2 is a graph showing the spreading diameter of various compositions including an adjuvant in accordance with the present technology.

FIG. 3 is a graph showing the spreading diameter of different adjuvant compositions including those in accordance with the present technology.

FIG. 4 is an image of cabbage leaves sprayed with various compositions including an adjuvant in accordance with the present technology.

FIG. 5 shows images of cabbage leaves sprayed with various compositions including an adjuvant in accordance with the present technology and subjected to a rain wash.

FIG. 6 is a graph showing the surface retention performance of various compositions including an adjuvant in accordance with the present technology applied to glass or parafilm surfaces and subjected to a rain wash.

FIG. 7 is a graph showing rainfastness of various compositions including an adjuvant in accordance with the present technology applied to parafilm and subjected to rain wash.

FIG. 8a is a graph showing the percentage of driftable fines for three trials using a composition in accordance with the present technology.

FIG. 8b is a graph showing the relative span of spray droplets for three trials using a composition in accordance with the present technology.

FIG. 9 is a graph comparing the hanging-drop evaporation speed of various formulations including formulations in accordance with the present technology.

FIG. 10 is the UV-VIS percent transmittance (% T) of a composition in accordance of the present invention.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The term “adjuvant” as used herein includes a component or components that impart a functionally useful property to an agricultural composition such as, but not limited to, dispensing, wetting, spreading, and the like, and/or enhances a functionally useful property already possessed in some degree by such composition including any material, or substance which increases the efficacy of an active material, agrochemical, and the like to which it is added.

The term “active” refers to an agricultural chemical or biological material, including but not limited to pesticides, e.g., herbicides, fungicides, insecticides, acaricides and molluscides; plant nutrients; defoliants; and plant growth regulators.

The term “agrochemical,” or “agricultural chemical,” or “biological” as used herein shall be understood to refer to all active compounds, biological materials including extracts, fractions and by-products thereof, living organisms including microorganisms, and the like, that are suitable for agricultural use such as pesticides, herbicides, fungicides, insecticides, nematocides, larvacides, mitocides, ovacides, plant growth regulators, seed treatment agents, etc.

The term “agricultural composition” refers to a composition that is applied to plants, weeds, landscapes, grass, trees, pastures, or for other agricultural applications. Agricultural compositions can be provided in concentrated or diluted form. An agricultural composition may or may not contain an agrochemical (agricultural chemical).

“Surfactants” can improve spray deposition properties by reducing the surface tension of the agricultural composition to which they are added, which may be a solution, mixture, dispersion or emulsion and thereby enhance droplet adhesion on foliar surfaces. As used herein, the term surfactant will include emulsifiers, dispersants and spreaders that affect the surface tension of compositions to which they are added.

Rainfastening or rainfastness refers to the ability of an active ingredient to remain available on a substrate, e.g., a crop, for a longer time when exposed to wet, windy or rainy conditions. The terms “rainfastening” and “rainfastness” are used interchangeably herein. In embodiments, rainfastening refers to the ability of an active or agrochemical ingredient to be held on an agricultural substrate (e.g., a leaf, stem, soil, fruit, or the like). In one embodiment, rainfastness refers to the condition such that at least 10% of an amount deposited on a Parafilm® M (Amcor) substrate may be recovered from the substrate when said substrate is subject to simulated rainfall equivalent to 7 mm in an hour, said simulated rain commencing 120 minutes after application of the substance in conditions of relative humidity of 50% or less.

Rainfastness can be evaluated qualitatively by observation of the droplets or deposits retained on a substrate, e,g., a crop such as, but not limited to, cabbage, canola, poinsettia, and tomato leaf, etc., when plants are subject to 9 mm simulated rain overnight after the application. Rainfastness can also be evaluated quantitatively by determining the amount of a dye retained on the substrate e,g., a crop such as, but not limited to, cabbage, canola, poinsettia, and tomato leaf, etc., when plants are subject to 7 mm simulated rain overnight after the application and the wash off solution is collected and analyzed by UV-VIS spectrophotometry.

The expression “hydrocarbon group” means any hydrocarbon from which one or more hydrogen atoms has been removed and is inclusive of alkyl, alkenyl, alkynyl, cyclic alkyl, cyclic alkenyl, cyclic alkynyl, aryl, aralkyl and arenyl groups and is inclusive of hydrocarbon groups containing at least one heteroatom.

The term “alkyl” means any monovalent, saturated straight, branched or cyclic hydrocarbon group; the term “alkenyl” means any monovalent straight, branched, or cyclic hydrocarbon group containing one or more carbon-carbon double bonds where the site of attachment of the group can be either at a carbon-carbon double bond or elsewhere therein; and, the term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl.

Provided is a composition suitable for use in conjunction with agrochemical compositions and for application to agricultural substrates. The compositions are suitable for aiding delivery of agrochemicals to agricultural substrates. In particular, the present compositions may provide one or more of enhanced adhesion to an agricultural substrate, droplet adhesion, spreadability, emulsion stability, reduced droplet evaporation and/or reduction in the formation of driftable fines (which refer to spray droplet particles of less than 105 μm). The compositions can function as sticker adjuvants. It will be appreciated that “sticker adjuvants” are agents that help active materials adhere to an agricultural substrate, thereby reducing the amount of active material that gets washed off by rain or irrigation. The present compositions can function as sticker adjuvants to enhance rainfastening of the agrochemical composition or contact pesticides to prevent early run off or wash off of the agrochemical composition upon exposure to water compared to an agrochemical composition without the sticker adjuvant, while providing excellent coverage on the substrate. The present compositions may also exhibit rainfastness in the sense that they may be retained on the surface of a substrate to which they are applied, and/or may infiltrate or penetrate the surface (e.g., penetrating the leaf). Thus, the present compositions can aid in delivery of agrochemicals to an agricultural substrate.

The present compositions provide an adjuvant composition comprising: (i) an unsaturated oil and/or a transesterified unsaturated oil; (ii) a trisiloxane alkoxylate surfactant, (iii) a vinyl lactam polymer and optionally, (iv) an alcohol.

### Unsaturated Oil/Transesterified Unsaturated Oil

The unsaturated oil may also be referred to herein as a seed oil.

The unsaturated oil can be selected from a natural oil, a synthetic oil, or fatty acid having an ethylenically unsaturated portion. These materials may also be referred to herein as ethylenically unsaturated oils. The ethylenically unsaturated oil may also include partially hydrogenated natural oils, genetically modified natural oils, and the like.

Examples of suitable ethylenically unsaturated oils include, but are not limited to, natural oils such as, but not limited to, bitter gourd, borage, calendula, canola, castor, china wood, coconut, conifer seed, corn, cottonseed, dehydrated castor, flaxseed, grape seed, Jacaranda mimosifolia seed, linseed, olive, palm, palm kernel, peanut, pomegranate seed, rapeseed, safflower, snake gourd, soya (bean), sunflower, tung, and/or wheat germ; synthetic oils such as, but not limited to, synthetic waxes (such as micro crystalline and/or paraffin wax), distilling tall oil (a by-product of processing pine wood) and/or synthesis (for example by chemical and/or biochemical methods); fatty acids such as, but not limited to, (Z)-hexadan-9-enoic [palmitoleic] acid (C₁₆H₃₀O₂), (Z)-octadecan-9-enoic [oleic] acid (C₁₈H₃₄O₂), (9Z,11E,13E)-octadeca-9,11,13-trienoic [α(alpha)-eleostearic also α-oleostearic] acid (C₁₈H₃₀O₂) (where α-eleostearic acid comprises >65% of the fatty acids of tung oil), licanic acid, (9Z,12Z)-octadeca-9,12-dienoic [linoleic] acid (C₁₈H₃₂O₂), (5Z,8Z,11Z,14Z)-eicosa-5,8,11,14-tetraenoic acid [arachidonic acid] (C₂₀H₃₂O₂), 12-hydroxy-(9Z)-octadeca-9-enoic [ricinoleic] acid (C₁₈H₃₄O₃), (Z)-docosan-13-enoic [erucic] acid (C₂₂H₄₂O₂), (Z)-eicosan-9-enoic [gadoleic] acid (C₂₀H₃₈O₂), (7Z,10Z,13Z,16Z,19Z)-docosa-7,10,13,16,19-pentaenoic [clupanodonic] acid; (1R,4aR,4bR,10aR)-1,4a-Dimethyl-7-(propan-2-yl)-1,2,3,4,4a,4b,5,6,10,10a-decahydrophenanthrene-1-carboxylic acid [abietic] acid (C₂₀H₃₀O₂); and/or combinations of two or more thereof.

The unsaturated oil can also be selected from a transesterified unsaturated oil. The transesterified unsaturated oil can be, for example, the reaction product of an ethylenically unsaturated oil and a trans-esterifying agent. The ethylenically unsaturated oil in the transesterified unsaturated oil can be any of the categories or types of oils mentioned above. The trans-esterifying agent is selected from a C1-C30 alcohol. In embodiments, the alcohol may have one, two or more hydroxy groups (which may also be referred to herein as a polyol). Examples of suitable alcohols as the trans-esterifying agent include, but are not limited to, methanol, ethanol, propanol, butanol, ethylene glycol, diethylene glycol, dipropylene glycol, 1,2-ethanediol, 1,3-propane diol, 1,4-butanediol, 1,6-hexane diol, 1,12-dodecane diol, 3-methyl-1,5-pentane diol, 2,2,4-trimethyl-1,6-hexane diol, 2,2-dimethyl-1,3-propane diol (neopentyl glycol), 2-methyl-2-cyclohexyl-1,3-propane diol or 2-ethyl-2-butyl-1,3-propane diol, 1,2-, 1,3- and 1,4-cyclohexanediols and the corresponding cyclohexane dimethanols, and diols such as alkoxylated bisphenol A products, e.g., ethoxylated or propoxylated bisphenol A; glycerol, pentaerythritol, di-, tri-, and tetrapentaerythritol, neopentyl glycol, sorbitol, trimethylol propane (TMP), trimethylol ethane, di-trimethylol propane, 1,1,1-tris(hydroxymethyl)ethane (TME), bis-TMP, bis-pentaerythritol, sorbitol (1,2,3,4,5,6-hexahydroxyhexane), combinations of two or more thereof, and the like.

In one embodiment, the transesterified unsaturated oil is a methylated or ethylated unsaturated oil. In one embodiment, the transesterified unsaturated oil is selected from methylated soybean oil, methylated rape seed oil, methylated olive oil, methylated castor oil, methylated sunflower seed oil, methylated canola oil, methylated coconut oil, methylated corn oil, methylated cotton seed oil, methylated linseed oil, methylated palm oil, methylated peanut oil, methylated safflower oil, methylated sesame oil, ethylated soybean oil, ethylated rape seed oil, ethylated canola oil, ethylated olive oil, ethylated castor oil, ethylated sunflower seed oil, ethylated coconut oil, ethylated corn oil, ethylated cotton seed oil, ethylated linseed oil, ethylated palm oil, ethylated peanut oil, ethylated safflower oil, ethylated sesame oil, ethylated tung oil, and the like.

In one embodiment, the oil component is refined corn oil, which has been found to remarkably improve compatibility and emulsion stability of the composition compared to other oils.

The unsaturated oil/transesterified unsaturated oil may be present in the composition in an amount of from about 50 wt. % to about 90 wt. %, from about 55 wt. % to about 85 wt. %, from about 60 wt. % to about 80 wt. %, or from about 65 wt. % to about 75 wt. % based on the total weight of the composition.

### Trisiloxane Alkoxylate

The composition comprises a trisiloxane alkoxylate. The trisiloxane alkoxylate is selected from a trisiloxane comprising alkoxy groups and a polyalkyleneoxide group. The polyalkylenoxide group generally comprises ethylene oxide groups, but may also include propylene oxide groups and/or butylenoxide groups. In embodiments, the trisiloxane alkoxylate is selected from a trisiloxane alkoxylate comprising a polyalkyleneoxide group having ethylene oxide groups. The composition may include a mixture of trisiloxane alkoxylates having polyalkylene oxide groups, where the different trisiloxane alkoxylates have different formulas from one another.

In one embodiment, the trisiloxane alkoxylate is selected from a compound of the formula (I):

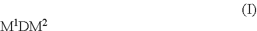

where

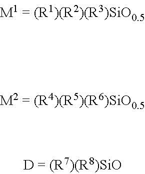

where
R¹, R², R³, R⁴, R⁵, and R⁷ are independently selected from the group consisting of a monovalent hydrocarbon radical having from 1-4 carbon atoms;
either R⁶ is R⁹ and R⁸ is Z, or Reis Z and R⁸ is R⁹,
where R⁹ is a monovalent hydrocarbon radical having from 1-4 carbon atoms;
Z is a polyalkyleneoxide group of the general formula:

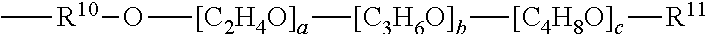

where subscript a is 2 to 9, b is 0 to 7, and c is 0 to 7,
2≤a+b+c<10, with a≥2, and with the proviso that if b+c=0, then a is 5 to 9;
R¹⁰ is a linear or branched divalent hydrocarbon group of 3 to 4 carbon atoms; and
R¹¹ is selected from the group consisting of H, monovalent hydrocarbon radicals of from 1 to 6 carbon atoms and acetyl.

In embodiments, the trisiloxane alkoxylate of Formula (I) is such that b+c is 0, and a is 5 to 9 or 6 to 8.

In one embodiment, the composition comprises a trisiloxane alkoxylate of Formula (I) and a trisiloxane alkoxylate of Formula (II):

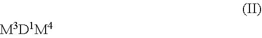

where

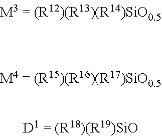

where
R¹², R¹³, R¹⁴, R¹⁵, R¹⁷, and R¹⁸ are independently selected from the group consisting of a monovalent hydrocarbon radical having from 1-4 carbon atoms;
either R¹⁶ is R²⁰ and R¹⁹ is Q, or R¹⁶ is Q and R¹⁹ is R²⁰,
R²⁰ is a monovalent hydrocarbon radical having from 1-4 carbon atoms;
Q is a polyalkyleneoxide group of the general formula:

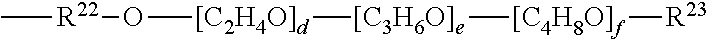

where subscript d is 3 to 35, e is 0 to 50, and f is 0 to 20, provided that e+f is ≥1, and 10≤d+e+f≤75 with d≥5; R²² is a linear or branched divalent hydrocarbon group of 3 to 4 carbon atoms; and
R²³ is selected from the group consisting of H, monovalent hydrocarbon radicals of from 1 to 6 carbon atoms and acetyl.

In one embodiment of the compound of Formula (II), e+f is from 0 to 50, e+f≥1, and 10≤d+e+f≤75, and d≥5.

In one embodiment, the composition comprises a trisiloxane alkoxylate of Formula (I) and a trisiloxane alkoxylate of Formula (II), wherein one of the following conditions is satisfied:

$$b + c = 0 , and a = 6 - 8 ;$$

$$a = 5 - 9 , b = 0 , c = 0 , d = 8 - 12 , e = 2 - 5 , f = 0 , and d + e + f \underline{>} 10 ;$$

$$a = 5 - 8 , b = 2 - 3 , c = 0 , a + b + c < 10 , d = 7 - 12 , e = 20 - 30 , and$$

$$f = 0 ;$$

$$a = 5 - 7 , b = 2 - 3 , c = 0 , a + b + c < 10 , d = 10 - 15 , e = 12 - 18 , and$$

$$f = 0 or 1 ; or$$

$$a = 5 - 7 , b = 1 - 3 , c = 0 , a + b + c < 10 , d = 10 - 15 , e = 12 - 18 , and$$

$$f = 0 or 1.$$

The trisiloxane alkoxylate may be present in an amount of from about 5 wt. % to about 30 wt. %, from about 10 wt. % to about 25 wt. %, or from about 15 wt. % to about 20 wt. % based on the total weight of the composition.

When the composition includes a mixture of a trisiloxane alkoxylate of Formula (I) and a trisiloxane alkoxylate of Formula (II), the ratio of trisiloxane alkoxylate of Formula (I) to trisiloxane alkoxylate of Formula (II) is about 90:10 to about 10:90, about 80:20 to about 20:80, about 70:30 to about 30:70, about 60:40 to about 40:60, or about 50:50 based on the total weight of the trisiloxane alkoxylate of Formula (I) and the trisiloxane alkoxylate of Formula (II).

In aspects and embodiments of the present technology, a blend of short chain trisiloxane alkoxylates and longer chain trisiloxane alkoxylates, including those shown in Formulas (I) and (II), significantly enhances emulsion stability compared to formulations containing only a trisiloxane alkoxylate of Formula (I).

In one embodiment, the trisiloxane alkoxylate may be blended or mixed with a surfactant. Suitable surfactants include, but are not limited to, anionic, cationic, nonionic and amphoteric surfactants, and polyelectrolytes. In embodiments, the surfactant blended with the trisiloxane alkoxylate is a non-silicone surfactant.

Some examples of suitable trisiloxane alkoxylate materials include, but are not limited to Silwet™ L-77, Silwet™ 408, Silwet™ L-7609, Silwet™ 806, Silwet™ 819, AgroSpred Prime, all available from Momentive Performance Materials, and the like.

Suitable anionic surfactants include, but are not limited to, alkali metal, alkaline-earth metal or ammonium salts of sulfonates, sulfates, phosphates or carboxylates. Examples of sulfonates are alkylarylsulfonates, diphenylsulfonates, alpha-olefinsulfonates, sulfonates of fatty acids and oils, sulfonates of ethoxylated alkylphenols, condensed naphthaline sulfonates, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants include, but are not limited to, alkoxylates (other than those of the trisiloxane alkoxylate type described above), N-alkylated fatty acid amides, aminoxides, ester-based or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide, preferably ethylene oxide, may be applied for the alkoxylation reaction. Examples of N-alkylated fatty acid amides are fatty acid glucamides or fatty acid alkanolamides. Examples of esters are fatty acid esters, glycerol esters, or monoglycerides. Examples of sugar-based surfactants are sorbitans, ethoxylated sorbitans, sucrose and glucose esters or alkylpolyglucosides. Other examples of suitable surfactants include, but are not limited to, alkoxylates, especially ethoxylates, containing block copolymers including copolymers of ethylene oxide, propylene oxide, butylene oxide, and mixtures thereof; alkylarylalkoxylates, especially ethoxylates or propoxylates and their derivatives including alkyl phenol ethoxylate; arylarylalkoxylates, especially ethoxylates or propoxylates, and their derivatives; amine alkoxylates, especially amine ethoxylates; fatty acid alkoxylates; fatty alcohol alkoxylates; guerbet alcohol alkoxylates. Suitable block polymers are block polymers of the A-B or of the A-B-A type comprising blocks of polyethylene oxide and polypropylene oxide or of the A-B-C type comprising alkanol, polyethylene oxide and polypropylene oxide

Suitable cationic surfactants are quaternary surfactants, for example quaternary ammonium compounds with one or two hydrophobic groups, or salts of long-chain primary amines. Alcohol alkyl sulfonates; alkyl benzene and alkyl naphthalene sulfonates; sulfated fatty alcohols, amines or acid amides; acid esters of sodium isethionate; esters of sodium sulfosuccinate; sulfated or sulfonated fatty acid esters; petroleum sulfonates; N-acyl sarcosinates; alkyl polyglycosides; alkyl ethoxylated amines; and the like.

Suitable amphoteric surfactants are phospholipids, alkylbetaines and imidazolines. Suitable polyelectrolytes are polyacids or polybases. Examples of polyacids are alkali metal salts of polyacrylic acid. Examples of polybases are polyvinylamines or polyethyleneamines.

Some specific examples of suitable surfactants include, but are not limited to, alcohol alkoxylates available under the designations Lutensol™ XL, Lutensol™ XP and Lutensol™ TDA available from BASF, Rhodasurf™ DA and Rhodasurf™ TR available from Syensqo, Ecosurf™ available from Dow, Tween® available from Croda, Tergitol™ from Dow, and the like.

Still some other examples of suitable surfactants include, but are not limited to, alkyl acetylenic diols (SURFONYL-Evonik), 2-ethyl hexyl sulfate, isodecyl alcohol ethoxylates (e.g., RHODASURF DA 530-Syensqo), ethylene diamine alkoxylates (TETRONICS-BASF), ethylene oxide/propylene oxide copolymers (PLURONICS-BASF), Gemini type surfactants (Syensqo) and diphenyl ether Gemini type surfactants (e.g. DOWFAX-Dow Chemical). Other particularly useful surfactants include, but are not limited to, ethylene oxide/propylene oxide copolymers (EO/PO); amine ethoxylates; alkyl polyglycosides; oxo-tridecyl alcohol ethoxylates, and the like.

The surfactant may be provided in an amount of from about 10% to about 40%, from about 15% to about 30%, or from about 20% to about 25% by weight of the total weight of the surfactant and the trisiloxane alkoxylate.

### Vinyl Lactam Polymer

The composition comprises a vinyl lactam copolymer. In embodiments, the vinyl lactam polymer is selected from a copolymer of (i) a heterocyclic vinyl lactam having 4 to 6 ring carbon atoms, and (ii) a (co) monomer selected from an olefin, a vinyl ester, or mixture thereof.

The vinyl lactam is selected from a lactam having 4 to 6 ring carbon atoms. Examples of suitable vinyl lactam monomers include, for example, N-vinyl pyrrolidone, N-vinyl caprolactam, vinyl methyl pyrrolidone, and the like.

The (co) monomer (ii) is selected from an olefin, a vinyl ester, or combination thereof. The olefin can be selected from a C2-C20 olefin, a C4-C18 olefin, a C6-C16 olefin, a C6-C14 olefin, or a C8-C10 oelfin. In embodiments, where the olefin is greater than 4 carbon atoms, the olefin is generally provided as an alpha-olefin.

Examples of suitable vinyl ester monomers for the monomer (ii) include, but are not limited to, vinyl formate, vinyl acetate, vinyl propionate, vinyl butyrate, vinyl isobutyrate, vinyl pivalate, vinyl versatate, vinyl caproate, vinyl caprylate, vinyl laurate, vinyl palmitate, vinyl stearate, vinyl oleate, vinyl benzoate, and the like.

The vinyl lactam polymer comprises from about 5% to about 95%, from about 10% to about 90%, from about 20% to about 80%, from about 25% to about 75%, from about 30% to about 70%, from about 35% to about 65%, or from about 40% to about 60% of the vinyl lactam, and from about 95% to about 5%, from about 90% to about 10%, from about 80% to about 20%, from about 75% to about 25%, from about 70% to about 30%, from about 65% to about 35%, or from about 60% to about 40% of the (co) monomer (ii). In embodiments, the vinyl lactam polymer comprises about 50% of the vinyl lactam, and about 50% of the (co) monomer (ii).

In embodiments, the vinyl lactam polymer is a vinylpyrrolidone copolymer comprising a copolymer of a vinylpyrrolidone and an alpha-olefin. The vinylpyrrolidone copolymer may comprise at least 5% of vinylprrolidone. In embodiments, the vinylpyrrolidone copolymer is a copolymer comprising 5% to 80% of vinylpyrrolidone and 20% to 95% of an alpha-olefin, 10% to 75% of vinylpyrrolidone and 25% to 90% of an alpha-olefin, 15% to 70% of vinylpyrrolidone and 30% to 80% of an alpha-olefin, 20% to 65% of vinylpyrrolidone and 35% to 80% of an alpha-olefin, 40% to 60% of vinylpyrrolidone and 40% to 60% of an alpha-olefin, or 50% of vinylpyrrolidone and 50% of an alpha-olefin. In embodiments, the vinylpyrrolidone copolymer comprises at least 15% of a vinylpyrrolidone.

In one embodiment, the vinylpyrrolidone copolymer can have a structure of the formula:

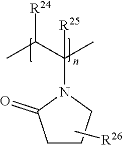

where
R²⁴, R²⁵, and R²⁶ are independently selected from H or a hydrocarbon group having from about 8 to about 22 carbon atoms, from about 10 to about 20 carbon atoms, from about 12 to about 18 carbon atoms, or from about 14 to about 16 carbon atoms.

The vinyl lactam polymer may have a number average molecular weight of from about 1,000 to about 100,000 g/mol, from about 1,500 to about 90,000 g/mol, from about 2,500 to about 80,000 g/mol, from about 5,000 to about 75,000 g/mol, from about 7,000 to about 50,000 g/mol, from about 10,000 to about 40,000 g/mol, from about 15,000 to about 30,000 g/mol, or from about 20,000 to about 25,000 g/mol. Molecular weight can be evaluated via GPC (gel permeation chromatography) and polyvinylpyrrolidone as standard.

The vinyl lactam polymer copolymer may be present in an amount of from about 5 wt. % to about 30 wt. %, from about 10 wt. % to about 25 wt. %, or from about 15 wt. % to about 20 wt. % based on the total weight of the composition.

### Alcohol

The composition comprises an aliphatic alcohol as an optional component. In embodiments, the alcohol is selected from synthetic and naturally derived alcohols, and can be a linear or branched alcohol. In embodiments, the alcohol comprises 1 to 24 carbon atoms, 4 to 22 carbon atoms, 6 to 20 carbon atoms, 8 to 18 carbon atoms, 10 to 16 carbon atoms, or 12 to 14 carbon atoms. In embodiments, the alcohol is selected from an alcohol having 8 to 24 carbon atoms, 10 to 20 carbon atoms, 12 to 18 carbon atoms, or 14 to 16 carbon atoms.

Suitable alcohols include, but are not limited to methanol, ethanol, propanol, isopropanol, 1-butanol, tert-butanol, 1-pentanol, isoamyl alcohol, 1-hexanol, 3-methyl-3-pentanol, 1-heptanol, 1-octanol, caprylic alcohol, 1-nonanol, 2-ethylhexanol, 1-nonanol, pelargonic alcohol, 1-decanol, 1-undecanol, 1-dodecanol, lauryl alcohol, tridecyl alcohol, myristyl alcohol, pentadecyl alcohol, cetyl alcohol, palmitoleyl alcohol, cetostearyl alcohol, heptadecyl alcohol, stearyl alcohol, oleyl alcohol, 1-octadecanol, isostearyl alcohol, nonadecyl alcohol, phytol, arachidyl alcohol, heneicosyl alcohol, behenyl alcohol, erucyl alcohol, 1-docosanol and lignoceryl alcohol.

An alcohol can be added in an amount of from about 0.1 wt. % to about 10 wt. %, from about 0.8 wt. % to about 9 wt. %, from about 1 wt. % to about 8 wt. %, from about 2 wt. % to about 7 wt. %, or from about 4 wt. % to about 6 wt. % based on the total weight of the composition.

In embodiments, the composition includes an alcohol in an effective amount to further enhance the formulation's compatibility and performance. The inclusion of a small amount of alcohol was found to yield a clear, stable mixture in formulations that may otherwise exhibit haziness or phase separation. Moreover, the alcohol-containing compositions may exhibit superior emulsion stability, improved spreading compared to the same formulation that does not contain an alcohol, which was unexpected given the relatively low levels of alcohol incorporated into the formula.

In embodiments, the adjuvant composition may be provided as a concentrate that is further mixed with an emulsifier or be pre-dispersed in water. Emulsifiers which may be advantageously employed herein may be readily determined by those skilled in the art and include various nonionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

A foam control agent may be included in the adjuvant composition in accordance with the present technology to suppress the formation of foam. Suitable foam control agents include, without limitation, silica-filled polydimethylsiloxanes or reaction products of silica and a polydimethyl-siloxane.

The amounts of foam control agent present in the adjuvant composition in accordance with the present technology can vary over a wide range, e.g., from 0.001 to 0.25, and more particularly from 0.005 to 0.1, weight percent based upon the total weight of the adjuvant composition thereof.

The adjuvant compositions may be employed to facilitate the contact of agrochemicals to agricultural substrates. In particular, compositions in accordance with the present technology have been found to be able to form a film layer and exhibit excellent adhesion to agricultural substrates. Further, the compositions in accordance with the present technology have been found to exhibit excellent rainfastness and are not easily washed off of a surface upon exposure to water.

The adjuvant composition can be employed as part of an agrochemical composition that may be applied to a biological or agricultural substrate. Suitable agrochemical compositions are made by combining, in a manner known in the art, such as, by mixing at least one agrochemical with an adjuvant in accordance with the present technology, either as a tank-mix, or as an “In-can” formulation.

The term “tank-mix” means the addition of at least one agrochemical to a spray medium, such as water or oil, at the point of use. The tank mix may be prepared, for example, by diluting a dispersion of the compositions in accordance with the present technology and at least one agrochemical to a desired concentration such as, but not limited to, the 2-fold to 100-fold, 5-fold to 40-fold, or 10-fold to 20-fold volume. Oils of various types, wetters, other adjuvants, and the like may also be added to the tank mix or else only immediately prior to preparing the tank mix from the dispersion. These agents can be admixed in a desired ratio weight ratio agent to the dispersion such as, but not limited to, 1:100 to 100:1, 1:50 to 50:1, 1:25 to 25:1, or 1:10 to 10:1.

The term “In-can” refers to a formulation or concentrate containing the compositions in accordance with the present technology and at least one agrochemical component. The “In-can” formulation may then diluted to use concentration at the point of use, typically in a Tank-mix, or it may be used undiluted.

The agrochemical employed is not particularly limited and can be selected as desired for a particular purpose or intended application. Suitable agrochemical ingredients include, but are not limited to, herbicides, insecticides, plant growth regulators, fungicides, miticides, acaricides, fertilizers, biologicals, plant nutritionals, micronutrients, biocides, and the like. Some other ingredients that may be added to the agrochemical composition include, but are not limited to paraffinic mineral oil, methylated seed oils (i.e. methylsoyate or methylcanolate), vegetable oils (such as soybean oil and canola oil), water conditioning agents, modified clays, foam control agents, surfactants, wetting agents, dispersants, emulsifiers, deposition aids and antidrift components. In one embodiment, the composition may optionally comprise additional surfactants (co-surfactants). Co-surfactants useful in the compositions herein include nonionic, cationic, anionic, amphoteric, zwitterionic, polymeric surfactants, or any mixture thereof. Moreover, other co-surfactants, that have short chain hydrophobes, such as, but not limited to, those described in U.S. Pat. No. 5,558,806, which is incorporated herein by reference, may also be useful.

The term “pesticide” herein means any compound used to destroy pests, e.g., rodenticides, insecticides, miticides, fungicides, herbicides, and the like. Typical uses for pesticides include agricultural, horticultural, turf, ornamental, home and garden, veterinary and forestry applications. The pesticidal formulations also include at least one pesticide. Optionally, the pesticidal formulation may include excipients, cosurfactants, solvents, foam control agents, deposition aids, drift retardants, biologicals, micronutrients, fertilizers, and the like. Illustrative examples of pesticides that can be employed include, but are not limited to mitotic disrupters, lipid biosynthesis inhibitors, cell wall inhibitors, and cell membrane disrupters. The amount of pesticide employed in agrochemical formulations may vary with the type of pesticide employed. More specific examples of pesticide compounds that can be used with the formulations include, but are not limited to, herbicides and growth regulators such as phenoxy acetic acids, phenoxy propionic acids, phenoxy butyric acids, benzoic acids, triazines and s-triazines, substituted ureas, uracils, bentazon, desmedipham, methazole, phenmedipham, pyridate, amitrole, clomazone, fluridone, norflurazone, dinitroanilines, isopropalin, oryzalin, pendimethalin, prodiamine, trifluralin, glyphosate, sulfonylureas, imidazolinones, dethodim, diclofop-methyl, fenoxaprop-ethyl, fluazifop-p-butyl, haloxyfop-methyl, quizalofop, sethoxydim, dichlobenil, isoxaben, and bipyridylium compounds.

Fungicide compositions that can be used include, but are not limited to, aldimorph, tridemorph, dodemorph, dimethomorph; flusilazol, azaconazole, cyproconazole, epoxiconazole, furconazole, propiconazole, tebuconazole and the like; imazalil, thiophanate, benomyl carbendazim, chlorothialonil; dieloran, trifloxystrobin, fluoxystrobin, dimoxystrobin, azoxystrobin, furcaranil, prochloraz, flusulfamide, famoxadone, captan, maneb, mancozeb, dodicin, dodine, and metalaxyl.

Insecticides, including larvacide, miticide and ovacide compounds that can be used include, but are not limited to, Bacillus thuringiensis, spinosad, abamectin, doramectin, lepimectin, pyrethrins, carbaryl, primicarb, aldicarb, methomyl, amitraz, boric acid, chlordimeform, novaluron, bistrifluron, triflumuron, diflubenzuron, imidacloprid, diazinon, acephate, endosulfan, kelevan, dimethoate, azinphos-ethyl, azinphos-methyl, izoxathion, chlorpyrifos, clofentezine, lambda-cyhalothrin, permethrin, bifenthrin, cypermethrin, and the like.

Fertilizers, and micronutrients include, but are not limited to, zinc sulfate, ferrous sulfate, ammonium sulfate, urea, urea ammonium nitrogen, ammonium thiosulfate, potassium sulfate, monoammonium phosphate, urea phosphate, calcium nitrate, boric acid, potassium and sodium salts of boric acid, phosphoric acid, magnesium hydroxide, manganese carbonate, calcium polysulfide, copper sulfate, manganese sulfate, iron sulfate, calcium sulfate, sodium molybdate, calcium chloride, or a combination of two or more thereof.

Biologicals are yet another class of actives that may include microbial and naturally derived additives that provide protection to a crop or plant. These may include essential oils (botanials), products of bio-fermentation, plant extracts, and the like. Some examples of biologicals include biostimulants, bioinhibitors, biofungicides, bioinsecticides, spinosads, and the like. Biologicals may be provided in any suitable form or from any suitable biological source. In embodiments, biologicals may be derived from microbial products such as, but not limited to, fermentation products (i.e. spinosids), or as microorganisms.

Examples of biostimulants or bioinhibitors, include, but are not limited to, enzymes, proteins, amino acids, micronutrients, salicylic acid, humic and fulvic acids, or protein hydrolases, and the like.

Examples of suitable biofungicides include, but not limited to, Trichoderma (e.g. Trichoderma harzianum), Bacillus subtilis, Bacillus amyloliquefaciens, Bacillus amyloliquefaciens, Bacillus subtilis, Trichoderma harzianum, and Streptomyces lydicus, and the like. One example of a biofungicide is Bacillus amyloliquefaciens strain MBI 600, Serifel® from BASF.

Examples of bioinsecticides include, but not limited to, Bacillus thuringiensis (BT), Burkholderia spp. (e.g. Venerate-Marrone), Chromobacterium subtsugae (e.g. Grandevo-Marrone), Isaria fumosorosea, Beauveria bassiana, Metarhizum anisopliae, and the like.

Examples of spinosads include, but are not limited to, Saccharopolyspora spinose, and the like.

Examples of botanicals include, but are not limited to, Pyrethrins, Botanical Oils (e.g. capsicum oleoresin extract, garlic oil, d-limonene, geraniol, cinnamon oil, ginger oil, clove oil, lavender oil, oregano oil, tea tree oil, fennel oil, thyme oil, rosemary oil, neem oil (neem extracts), and the like.

It will be appreciated that biopesticide actives may include, but are not limited to, those listed by EPA at https://www.epa.gov/ingredients-used-pesticide-products/biopesticide-active-ingredients.

Suitable agrochemical compositions are made by combining, in a manner known in the art, such as, by mixing one or more of the above components with the adjuvant compositions in accordance with the present technology, either as a tank-mix, or as an “In-can” formulation. The term “tank-mix” means the addition of at least one agrochemical to a spray medium, such as water or oil, at the point of use. The term “In-can” refers to a formulation or concentrate containing the silane composition and at least one agrochemical component. The “In-can” formulation may then diluted to use concentration at the point of use, typically in a Tank-mix, or it may be used undiluted.

The agrochemical compositions are not limited to use with a particular type of agricultural substrate and can be applied to soil or to various types of crops or vegetation to be intended to be treated with agrochemical composition.

The agrochemical compositions employing the adjuvants, methods of using such compositions, etc., can be employed to treat areas where a variety of crops, plants, etc., may be grown. Examples of suitable crop plants whose production and growth may be enhanced by the use of the present compositions, alone or in conjunction with fertilizers, pesticides, fungicides, etc., include, but are not limited to, nutrients, etc., include, but are not limited to, cereals, for example wheat, rye, barley, triticale, oats, rice, etc.; beet, for example sugar, fodder beet, etc.; pome fruit, stone fruit, and soft fruit, for example apples, pears, plums, peaches, almonds, cherries, strawberries, raspberries, currants, goose-berries, etc.; legumes, for example beans, lentils, peas, lucerne, soybeans, etc.; oil crops, for example oilseed rape, mustard, olives, sunflowers, coconut, cacao, castor beans, oil palm, peanuts, soybeans, etc.; cucurbits, for example pumpkins/squash, cucumbers, melons, etc.; fiber crops, for example cotton, flax, hemp, jute, etc.; citrus fruit, for example oranges, lemons, grapefruit, tangerines, etc.; vegetable plants, for example spinach, lettuce, asparagus, cabbages, carrots, onions, tomatoes, eggplant, potatoes, pumpkin/squash, radish, capsicums, etc.; plants of the laurel family, for example avocados, cinnamon, camphor, etc.; plants of the ginger family, for example, ginger, turmeric, cardamom, galangal, etc.; energy crops and industrial feedstock crops, for example maize, soybeans, wheat, oilseed rape, sugar cane, oil palm, etc.; maize; tobacco; nuts; coffee; tea; bananas; wine (dessert grapes and grapes for vinification); hops; grass, for example turf; sweetleaf (Stevia rebaudania); rubber plants, and forest plants, for example flowers, shrubs, deciduous trees, and coniferous trees, and propagation material, for example seeds, and harvested produce of these plants.

Aspects and embodiments of the present technology may be further understood with respect to the following examples. The examples are not intended to be limiting of any particular aspect of the invention.

### EXAMPLES

Adjuvant compositions were prepared according to the formulations in Table 1:

TABLE 1

| | | | | MFA- | MFA- | MFA- | Comp | Comp | Comp |
|---|---|---|---|---|---|---|---|---|---|
| | Component | Vendor | Description | 1 | 2 | 3 | A | B | C |
| Formulation | Vida-Care AVP-16 | Alfa | Vinylpyrrolidone | 20% | 20% | 20% | 0 | 20% | 20% |
| | | Chemicals | copolymer | | | | | | |
| | TSA-1* | Momentive | Trisiloxane | | 20% | | | | |
| | | | alkoxylate | | | | | | |
| | TSA-2** | Momentive | Blend of | 20% | | 15% | 20% | 0 | 20% |
| | | | Trisiloxane | | | | | | |
| | | | alkoxylate | | | | | | |
| | | | surfactants | | | | | | |
| | Tergitol 15-S-12 | Dow | Non-ionic | 0 | | 5% | 0 | 20% | 0 |
| | | | surfactant | | | | | | |
| | Corn oil | | Oil | 60% | 60% | 60% | 80% | 60% | |
| | Methyl Soyate | | Methylated | | | | | | 60% |
| | | | Seed Oil | | | | | | |
| Property | Emulsion Stability | | | 1.5 | 2.8 | 2.4 | 10 | 2.5 | 3.2 |
| | (1%) | | | | | | | | |
| | Rainfastness (0.2%) | | | +++ | +++ | +++ | − | ++ | ++ |
| | Spreading & | | | ++ | +++ | ++ | +++ | + | + |
| | Coverage (0.2%) | | | | | | | | |
| | Anti-drift (0.25%) | | | +++ | +++ | +++ | ++ | +++ | ++ |

*Trisiloxane alkoxylate falling under Formula (I) where b and c are each 0, a is 6-8, and R¹¹ is H
**Trisiloxane alkoxylate is a mixture of (i) a compound of Formula (I) where b and c are each 0, a is 6-8, and R¹¹ is H, and (ii) a compound of Formula (II) where d is 10-15, e is 12-18, fis 0, and R²³ is H

### Emulsion Stability

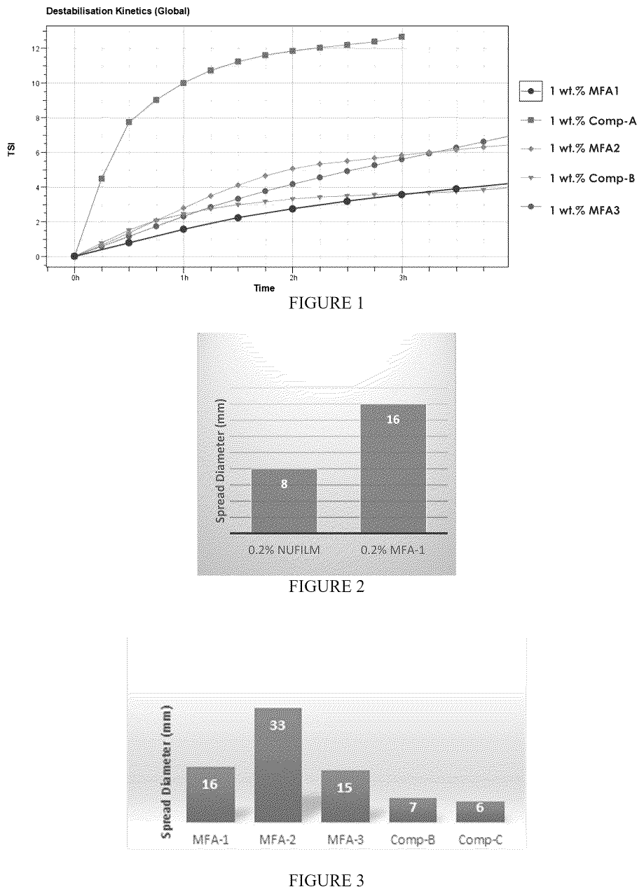

The Turbiscan Stability Index (TSI) of the respective adjuvants was evaluated. FIG. 1 is a graph showing the TSI of the compositions over a period of 4 hours. Examples MFA-1 and MFA-2 provide superior levels of spreading and superior emulsion stability compared to Comp A and Comp C without the need for a non-silicone non-ionic surfactant. Comp-A, which lacks the lactam copolymer, shows the worst emulsion stability. Compared with Comp-B, compositions in accordance with the present technology show a synergy on emulsion stability when the TSA and the lactam polymer are incorporated together, especially at the initial 3 hours.

### Spreading

Spreading of Example MFA-1 was compared to that of a market benchmark (NuFilm from Miller Chemical). Both materials were tested at 0.2% in DI water. As shown in FIG. 2, MFA-1 significantly outperformed the NuFilm material.

The components may also provide a synergistic effect on spreading. The testing of different oils was evaluated. A composition of the pyrrolidone copolymer (Vida-Care AVP-16), trisiloxane alkoxylate (TSA-2), and methylated seed oil was prepared (Comp C). This composition is the same as MFA-1 except for the use of methylated seed oil. As shown in FIG. 3, Comp C had a spreading diameter similar to Comp B, which did not have the trisiloxane alkoxylate material. In contrast, the compositions with the pyrrolidone copolymer, trisiloxane alkoxylate, and corn oil as the oil component exhibited significant increases in spreading.

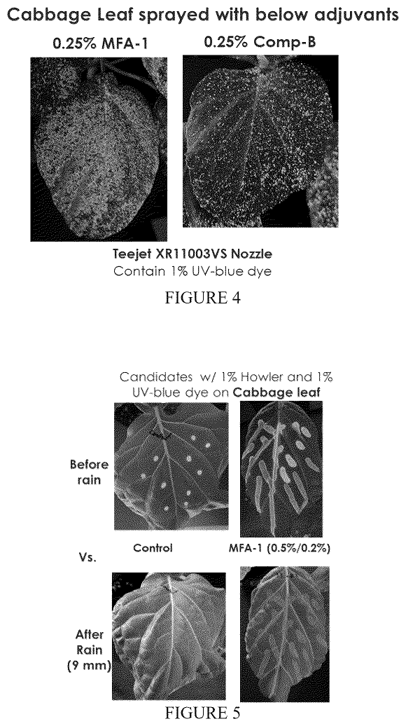

Compositions were also sprayed on cabbage leaf to evaluate spreading. The compositions were applied at the same condition with a Teejet XR11001VS nozzle. Compositions with 0.25 wt. % of MFA-1 and Comp B were applied to cabbage leaves. As shown in FIG. 4, the composition with MFA-1 covers over 90% of the cabbage leaf, while the spray with Comp B covers significantly less of the leaf.

### Rainfastness

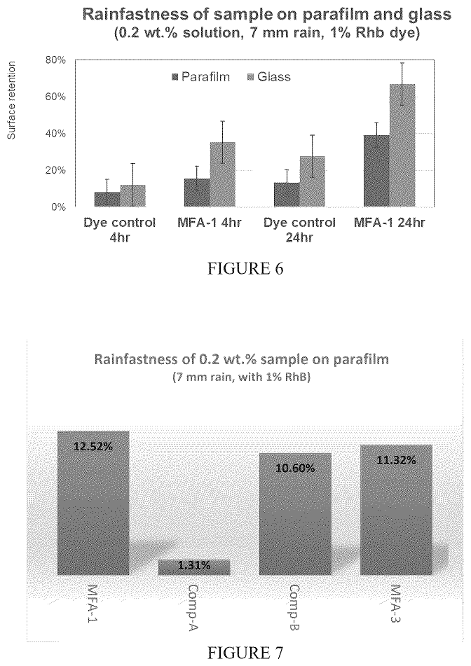

A simulated rain test inspired by AATCC Test Method 22-2005 was used to investigate the rainfastness of the Rhodamine B dye on the substrates. Briefly, 8 drops of 10 microliters of the mixture with 1 wt % Rhodamine B and 0.2 wt % samples MFA-1, MFA-3, Comp-A, Comp-B were dried on 75 mm×25 mm glass slide and 75 mm×25 mm parafilm substrates for three hours, respectively. The substrates were placed at an angle of 45 degree below the spray nozzle, respectively. The spray nozzle was fitted at the bottom of a 155 mm diameter funnel and the distance between the surface of the wafer and the spray nozzle was maintained at 150 mm in all the cases. 125 ml of deionized (“DI”) water (equivalent to 7 mm/second of rainfall) was poured through the funnel and were sprayed on the wafers for a minute. Surfaces of the ambient dried parafilms and glass slide wafers after the washing off were recorded by photography. The concentration of the Rhodamine B in the washed-off water was calculated based on the standard curve of Rhodamine B solutions of known concentrations. In addition, the retention of the dye at surface after washing off (so called rainfastness) was calculated based on the concentration of the dye in the washed-off water. The compositions used as bench mark controls were 1 wt % Rhodamine B aqueous solution without additives (Dye Control). Results are plotted in FIG. 6 and FIG. 7. FIG. 6 demonstrates that the samples with MFA-1 show significantly improved rainfastness versus the control on both glass slides and Parafilm M. FIG. 7 indicates that MFA-1 shows 9.56 times more rainfastness capacity than Comp A, and 18% improvement over Comp B.

Rainfastness was also evaluated by visual inspection to check the amount of active ingredient left on plant leaves with 1% UV-blue dye as the visual indicator. A control without the present technology was applied to a cabbage leaf. A cabbage leaf was also sprayed with an adjuvant that is 0.5% of MFA-1 on the left half of the leaf, and an adjuvant with 0.25% of MFA-1 on the right half of the leaf. The leaves were treated with a simulated rain wash for 12 minutes inside the spray booth, which was equivalent to 9 mm rain wash. FIG. 5 are images of the leaves before and after the rain wash. The composition of MFA-1 shows greatly enhanced rainfastness compared to the control.

### Drift Reduction

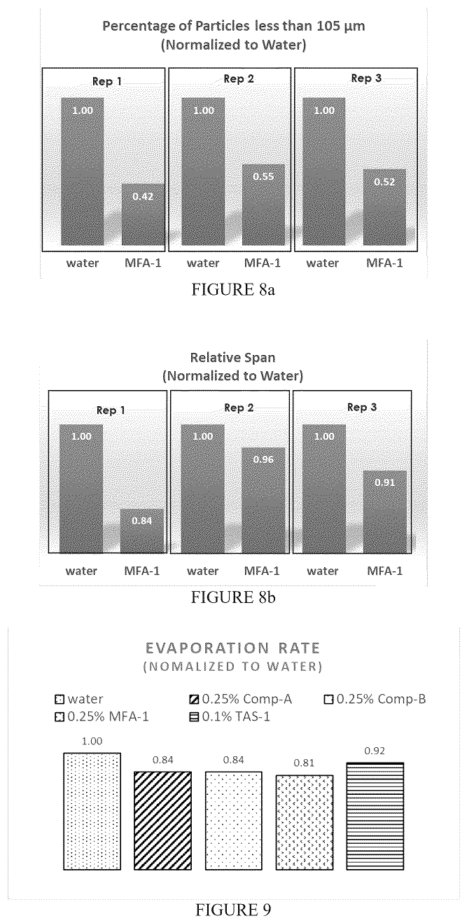

Compositions of 0.25 wt. % MFA-1 were sprayed inside a DeVries Gen 4 spray booth with a Teejet 11001VS nozzle, and the droplet size was measured with an Oxford laser P15. Water was used as the control. The compositions with MFA-1 reduced the driftable fines by 42% to 55% of that of water from 3 repeated tests on different days. (See FIG. 8a.) As shown in FIG. 8b, the composition with MFA-1 gave a more uniform droplet size distribution compared to the control.

### Anti-Evaporation

FIG. 9 shows the comparison of hanging-drop evaporation speed of certain formulations. The composition with MFA-1 showed reduced levels of droplet evaporation compared to the controls.

### Compositions Containing an Alcohol

The vinylpyrrolidone copolymer and trisiloxane alkoxylates of formulas (I) and (II) are mutually insoluble. A homogeneous, single-phase system is achieved when both components are dissolved in vegetable oils. A clear, stable mixture was obtained using corn oil, whereas sunflower and rapeseed oils produced hazy, unstable mixtures. It was found that incorporating small amounts of alcohol into the composition functions as a compatibilizing agent, enabling a clear, stable mixture regardless of the vegetable oil source. Furthermore, the addition of alcohol was unexpectedly found to enhance the spreading properties and emulsion stability of the final formulation beyond anticipated levels. Table 2 below illustrates some of these findings.

TABLE 2

| | MFA-4 | MFA-5 | MFA-6 | MFA-7 | MFA-8 |
|---|---|---|---|---|---|
| TSA-2* | 20% | 20% | 20% | 20% | 20% |
| AVP-16 | 15% | 15% | 15% | 15% | 15% |
| Corn oil | 55% | 55% | 63% | 63% | |
| Rapeseed oil | | | | | 63% |
| 1-decanol | 10% | | | 2% | 2% |
| 1-octadecanol | | 10% | 2% | | |
| Emulsion Stability¹ | 4 | 3 | 3 | 2.3 | 2.8 |
| Rainfastening (0.15%) | ++ | ++ | ++ | ++ | ++ |
| Spreading Diameter | 21.8 | 24.2 | 19.8 | 21.3 | 21.0 |
| (mm) @0.2 wt. %) | | | | | |

*Product with a composition according to Formula (1) and (2) having a 50/50 ratio
¹Emulsion stability expressed by their TSI value (Turbiscan Stability Index) with Turbiscan Lab and corresponding software at time = 1 hour. Lower numbers indicate a more stable emulsion.

### UV Protection

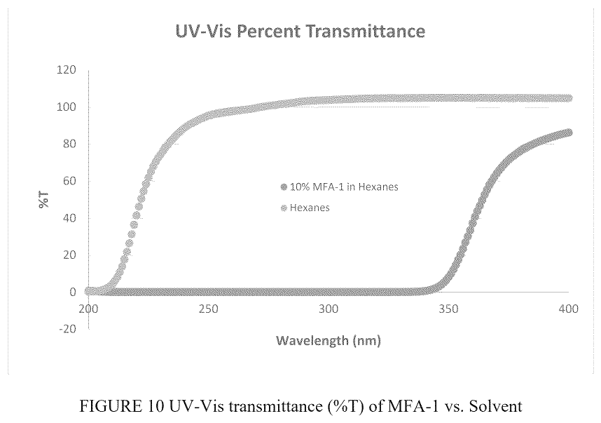

Biologicals, particularly microbial pesticides, can be especially sensitive to exposure to natural ultraviolet (UV) radiation as UV light may damage or inactivate the microbial cells, spores, or proteins that are responsible for pest control. Therefore, exposure to sunlight after application can rapidly decrease the viability and potency of these biological agents, leading to reduced efficacy and shorter residual activity in the field. It will be appreciated that the composition of the present invention also exhibits UV protection properties, as determined by the UV absorption spectrum. FIG. 10 shows the UV/VIS % Transmittance (% T), where it is shown that MFA-1 helps protecting microbial pesticides from sunlight deactivation by absorbing UV light in the 200 to 350 nm range.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an adjuvant, compositions comprising the same including agrochemical compositions, and methods of treating agricultural substrates with such materials and compositions. Modifications may occur to those skilled in the art and to those who may make and use the invention. The disclosed embodiments are merely for illustrative purposes and not intended to limit the scope of the invention or the subject matter set forth in the claims.

What is claimed is:

1. An adjuvant composition comprising:
an oil selected from a seed oil, a transesterified seed oil, or mixture thereof, wherein the oil is present in an amount of from about 50% to about 90% by weight of the composition;
a trisiloxane alkoxylate in an amount of from about 5% to about 30% by weight of the composition; and
a vinyl lactam polymer in an amount of from about 5% to about 30% by weight of the composition.

2. The composition of claim 1, wherein the seed oil is selected from bitter gourd oil, borage oil, calendula oil, canola oil, castor oil, china wood oil, coconut oil, conifer seed oil, corn oil, cottonseed oil, dehydrated castor oil, flaxseed oil, grape seed oil, Jacaranda mimosifolia seed oil, linseed oil, olive oil, palm oil, palm kernel oil, peanut oil, pomegranate seed oil, rapeseed oil, safflower oil, snake gourd oil, soya (bean) oil, sunflower oil, tung oil, wheat germ oil, or a mixture of two or more thereof.

3. The composition of claim 1, wherein the transesterified seed oil is selected from a methylated or ethylated seed oil.

4. The composition of claim 1, wherein the oil comprises corn oil.

5. The composition of claim 1, wherein the oil comprises methylate soybean oil, methylated rapeseed oil or ethylated canola oil.

6. The composition of claim 1, wherein the trisiloxane alkoxylate comprises a compound of the formula (I): 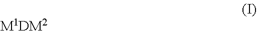 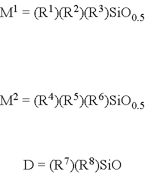
where
where
R¹, R², R³, R⁴, R⁵, and R⁷ are independently selected from the group consisting of a monovalent hydrocarbon radical having from 1-4 carbon atoms;
either R⁶ is R⁹ and R⁸ is Z, or R⁶ is Z and R⁸ is R⁹, where R⁹ is a monovalent hydrocarbon radical having from 1-4 carbon atoms;
Z is a polyalkyleneoxide group of the general formula: 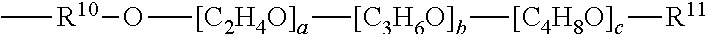
where subscript a is 2 to 9, b is 0 to 7, and c is 0 to 7, and satisfy the following relationships:
$$2 \leq a + b + c < 10 , with a \geq 2$$
and with the limitation that when b+c=0, then a is 5 to 9,
R¹⁰ is a linear or branched divalent hydrocarbon group of 3 to 4 carbon atoms; and
R¹¹ is selected from the group consisting of H, monovalent hydrocarbon radicals of from 1 to 6 carbon atoms and acetyl.

7. The composition of claim 6 wherein b+c is 0.

8. The composition of claim 6 further comprising a trisiloxane alkoxylate of the formula (II); 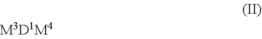
where 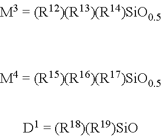
where
R¹², R¹³, R¹⁴, R¹⁵, R¹⁷, and R¹⁸ are independently selected from the group consisting of a monovalent hydrocarbon radical having from 1-4 carbon atoms;
either R¹⁶ is R²⁰ and R¹⁹ is Q, or R¹⁶ is Q and R¹⁹ is R²⁰, where R²⁰ is a monovalent hydrocarbon radical having from 1-4 carbon atoms;
Q is a polyalkyleneoxide group of the general formula: 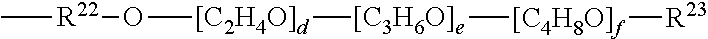
where subscript d is 3 to 35, e is 0 to 50, and f is 0 to 20, provided that e+f is ≥1, and
10≤d+e+f≤75 with d≥5;
R²² is a linear or branched divalent hydrocarbon group of 3 to 4 carbon atoms; and
R²³ is selected from the group consisting of H, monovalent hydrocarbon radicals of from 1 to 6 carbon atoms and acetyl.

9. The composition of claim 6, wherein b+c=0, and a=6=8.

10. The composition of claim 7, wherein a=5-9, b=0, c=0, d=8-12, e=2-5, f=0, and d+e+f≥10.

11. The composition of claim 8, wherein a=5-8, b=2-3, c=0, a+b+c<10, d=7-12, e=20-30, and f=0.

12. The composition of claim 8, wherein a=5-7, b=2-3, c=0, a+b+c<10, d=10-12, e=12-18, and f=0 or 1.

13. The composition of claim 8, wherein a=5-7, b=1-3, c=0, a+b+c<10, d=10-12, e=12-18, and f=0 or 1.

14. The composition of claim 8, wherein a ratio of the trisiloxane alkoxylate of the Formula (I) to the trisiloxane alkoxylate of the Formula (II) is from about 90:10 to about 10:90 based on the total weight of the trisiloxane alkoxylate of Formula (I) and the trisiloxane alkoxylate of Formula (II).

15. The composition of claim 1, wherein the vinyl lactam polymer is selected from a copolymer of (i) a heterocyclic vinyl lactam having 4 to 6 ring carbon atoms, and (ii) a (co) monomer selected from an olefin, a vinyl ester, or mixture thereof.

16. The composition of claim 15, wherein the heterocyclic vinyl lactam is selected from N-vinyl pyrrolidone, N-vinyl caprolactam, or vinyl methyl pyrrolidone.

17. The composition of claim 15, wherein the (co) monomer is selected from a C2-C20 olefin.

18. The composition of claim 15, wherein the monomer is selected from vinyl formate, vinyl acetate, vinyl propionate, vinyl butyrate, vinyl isobutyrate, vinyl pivalate, vinyl versatate, vinyl caproate, vinyl caprylate, vinyl laurate, vinyl palmitate, vinyl stearate, vinyl oleate, vinyl benzoate, or a mixture of two or more thereof.

19. The composition of claim 15, wherein the vinyl lactam polymer comprises from about 5% to about 95% of the vinyl lactam (i), and from about 95% to about 5% of the (co) monomer (ii).

20. The composition of claim 15, wherein the vinyl lactam polymer comprises a vinylpyrrolidone copolymer comprising a copolymer of a vinylpyrrolidone and an alpha-olefin.

21. The composition of claim 1, wherein the vinyl lactam polymer has a number average molecular weight of from about 1,000 to about 100,000.

22. The composition of claim 1, wherein the vinyl lactam polymer is soluble in the oil.

23. The composition of claim 1 further comprising an alcohol.

24. The composition of claim 23, wherein the alcohol has 1 to 24 carbon atoms.

25. The composition of claim 24, wherein the alcohol has 8 to 24 carbon atoms.

26. The composition of claim 23, wherein the alcohol is present in an amount of from about 0.1 wt. % to about 10 wt. % based on the weight of the composition.

27. The composition of claim 23, wherein the oil is bitter gourd, borage, calendula, canola, castor, china wood, coconut, conifer seed, corn, cottonseed, dehydrated castor, flaxseed, grape seed, Jacaranda mimosifolia seed, linseed, olive, palm, palm kernel, peanut, pomegranate seed, rapeseed, safflower, snake gourd, soya (bean), sunflower, tung, and/or wheat germ, or a mixture of two or more thereof.

28. The composition of claim 1, wherein the composition provides microbial pesticides or biochemical pesticides with protection from ultraviolet radiation.

29. An agrochemical composition comprising the adjuvant composition of claim 1 and an agrochemical.

30. An agrochemical composition comprising the adjuvant composition of any one of claim 1 and a microbial pesticide, wherein the composition provides the microbial pesticide with protection from ultraviolet radiation.

31. The agrochemical composition of claim 29, wherein the agrochemical is selected from a herbicide, an insecticide, a plant growth regulator, a fungicide, a miticide, an acaricide, a fertilizer, a biocide, a micronutrient, a plant nutritional, a microbial pesticide, a biochemical pesticide, a biostimulant, or a combination of two or more thereof.

32. A method of treating an agricultural substrate comprising applying an agrochemical and the composition of claim 1 to an agricultural substrate.

33. The method of claim 32, wherein the agrochemical and the adjuvant composition are provided as a pre-mixed solution.

34. The method of claim 32, wherein the adjuvant composition is provided as a tank side additive and is applied to the agricultural substrate at the same time or after application of the agrochemical.

35. The method of claim 32, wherein the agricultural substrate is selected from the group consisting of a foliar substrate, seed substrate and a shoot substrate.

36. Use of an adjuvant composition of claim 1 for improving the rainfastness of an agricultural composition.

37. The use of claim 36, wherein an agrochemical ingredient of said agricultural composition is held on an agricultural substrate in an amount such that more than 10% of an amount deposited on a Parafilm M substrate is recovered from the substrate when said substrate is subject to simulated rainfall equivalent to 7 mm in an hour, said simulated rain commencing 120 minutes after application of the substance in conditions of relative humidity of 50% or less.

38. A method for imparting rainfastness to an agrochemical, the method comprising contacting the agrochemical with the adjuvant composition of claim 1 to prepare a rainfastening agrochemical composition and dispensing the rainfastening agrochemical composition on an agricultural substrate.
